(19) United States
(12) Patent Application Publication
(10) Pub. No.: US 2010/0191734 A1
(43) Pub. Date: Jul. 29, 2010

(54) SYSTEM AND METHOD FOR CLASSIFYING DOCUMENTS

(76) Inventors: Shyam Sundar Rajaram, Mountain View, CA (US); Martin B. Scholz, San Francisco, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/359,240

(22) Filed: Jan. 23, 2009

(51) Int. Cl. G06F 17/30

(52) U.S. Cl. 707/739; 707/E17.046

(57) ABSTRACT

A method of classifying a plurality of documents that form part of a data set comprises retrieving the plurality of documents from a computing device and applying a hashing representation scheme to the plurality of documents from the data set to obtain a feature vector representation of each of the plurality of documents. A classification label is associated with selected documents of the plurality of documents in the data set. A learning algorithm is executed to learn a functional relationship between the feature vector representations of the plurality of documents and the classification label associated with the at least one document. The functional relationship learned is utilized to associate classification labels with feature vector representations of other documents of the data set so as to provide document classifications.

### BACKGROUND

In times of increasingly web-oriented information architectures, it becomes more and more natural to push analytical software down to clients, then have them report back unique and prototypical events that desire additional attention or indicate specific business opportunities. Examples of this type of system include analytical software running on user computing devices (e.g., personal computers) such as spam filtering, “malware” detection, and diagnostic tools for different types of system functions.

These types of applications can be particularly complex in the overall family of classification problems where high-dimensional, sparse training data is available on a large number of clients. Such applications often consume significant resource consumption of network bandwidth, memory and CPU footprints.

Conventional systems utilized to treat sparse data such as this include “bag of words” representations and variants thereon. However, these solutions have proved impractical because of the size of vocabulary. An alternative conventional approach is to use feature selection methods, which are unfortunately problem specific (e.g., there is a different set of features for each problem and hence a lack of generality which does not allow for a dynamic taxonomy).

A closely related alternative is the random projection method, which is relatively simple and has nice theoretical Euclidean distance preserving properties. However, this method has not proven to be sufficiently compact and efficient.

### BRIEF DESCRIPTION OF THE DRAWINGS

FIG. 1 is a flow chart illustrating a method of classifying a plurality of documents that form part of a data set in accordance with an embodiment;

FIG. 2 is a block diagram representation of a system for classifying a plurality of documents that form part of a data set in accordance with an embodiment; and

FIG. 3 is a block diagram representation of one way of generating hash vectors in accordance with an embodiment of the invention.

### DETAILED DESCRIPTION

Alterations and further modifications of the inventive features illustrated herein, and additional applications of the principles of the inventions as illustrated herein, which would occur to one skilled in the relevant art and having possession of this disclosure, are to be considered within the scope of the invention. The same reference numerals in different drawings represent the same element.

A powerful and general feature representation is provided that is based on a locality sensitive hash scheme called random hyperplane hashing. The system addresses the problem of centrally learning (linear) classification models from data that are distributed on a number of clients. The invention advantageously balances the accuracy of individual classifiers and different kinds of costs related to their deployment, including communication costs and computational complexity. The invention thus addresses: the ability of schemes for sparse high-dimensional data to adapt to the much denser representations gained by random hyperplane hashing, how much data has to be transmitted to preserve enough of the semantics of each document, and how the representations affect the overall computational complexity.

The present invention aims to classify data and documents with respect to a quickly changing taxonomy of relevant concepts. The constraints in this setting stem from the natural goal of minimizing resource consumption on clients, including network bandwidth and memory and CPU footprint of classifiers and related software.

Generally speaking, a cycle of training and deploying classifiers involves the following phases. First, data is preprocessed on clients before it is uploaded to a server. The preprocessing is generally done so as to reduce data volumes, and can also be used to preserve privacy. The classifiers are learned on the server, after which clients download these potentially large number of classifiers. As the number of classifiers can be large, it is desired to minimize the bandwidth. Finally, the models are deployed on the clients and triggered for each document under consideration.

As such, the invention is concerned with the associated costs of preprocessing each document and of applying a linear classifier on top of that representation. The invention provides representations of sparse and high-dimensional data that are compact enough to be transmitted over the web, general enough to be used for all kinds of multi-class classification problems, cheap enough to be applicable at deployment time, and are close enough to the performance of the models such that they are not narrowed down by operational costs.

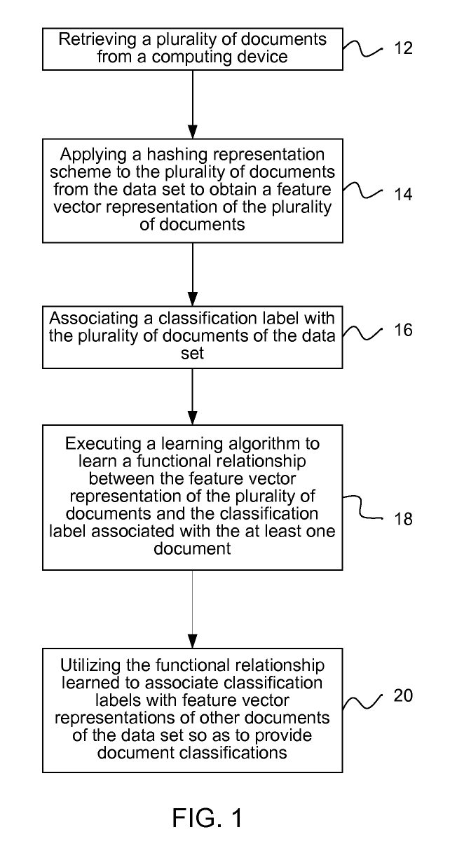

As shown generally in FIG. 1, in one embodiment, a method is provided for classifying a plurality of documents that form part of a data set. The method can include, at block 12, retrieving a plurality of documents from a database located on a computing device. Such computing device can, but does not necessarily, include one or more personal computing devices. At block 14, the method can include applying a hashing representation scheme to the plurality of documents from the data set to obtain a feature vector representation of the plurality of documents. Each of these steps can be performed at the location of the personal computing device.

At block 16, a classification label can be associated with the plurality of documents of the data set. At block 18, a learning algorithm can be executed to learn a functional relationship between the feature vector representation of the plurality of documents and the classification label associated with at least one document. At block 20, the functional relationship learned can be utilized to associate classification labels with feature vector representations of other documents of the data set so as to provide document classifications. Each of these steps can be performed on a server. By performing the initial retrieval and hashing representation scheme at the personal computer, and the remainder of the process at the server, the bandwidth required for the process can be significantly reduced.

In one embodiment, the locality sensitive hashing scheme generates a hash space in which a distance between documents in the data set is preserved, or represented by a distance in, the hash space.

The method can include obtaining a vector representation for a document by a set of feature vectors for a document. The dimensionality of the set of feature vectors can be reduced. Associating a classification label can include applying classification labels to a portion of the documents.

A more detailed description of specific embodiments of the invention can be outlined as follows. The following terminology is used: R^{N} is the space of all N dimensional real vectors. For a vector v ε R^{N}, vᵢ represents the iₜₕ element of v. The length of a vector vε R^{N} is defined as

$$\sqrt{{\sum }_{i = 1}^{N} {v}_{i}^{2}} .$$

The notation l(v) is used to denote the length of a vector. The inner product of two vectors v, u ε R^{N} is defined as

$${\sum }_{i = 1}^{N} {v}_{i} {u}_{i} .$$

The notation u.v is used to denote the inner product. The cosine of two vectors u and v is defined as

$$cos ( u , v ) = \frac{u \cdot v}{l ( u ) l ( v )} .$$

Often the vectors are first normalized by dividing them with the length (i.e. they are of unit length), in which case the cosine of the vectors is the same as their inner product.

Generally speaking, a classification problem is a supervised learning problem wherein, given a training data set of M pairs of instances x,y where x is an N dimensional vector and y represents the class label (0 or 1 in the binary case and 1,2 . . . K for a K-class classification problem), it is desired to learn a classifying function f that can map from the N-dimensional vector to the label space (e.g., learn a function such that f(x)=y. The “goodness” of the learned classifier f is evaluated on a test set. Perceptron, Support Vector Machine, and Naïve Bayes are ways by which such a classifier can be learned.

The present invention is a representation scheme for documents based on a locality sensitive hashing (LSH) technique called as random hyper plane hashing. Locality sensitive hashing is a technique developed to perform similarity based nearest neighbor search where, vectors are mapped into a small set of hashes in such a way that two similar vectors will lead to highly overlapping hash sets with high probability.

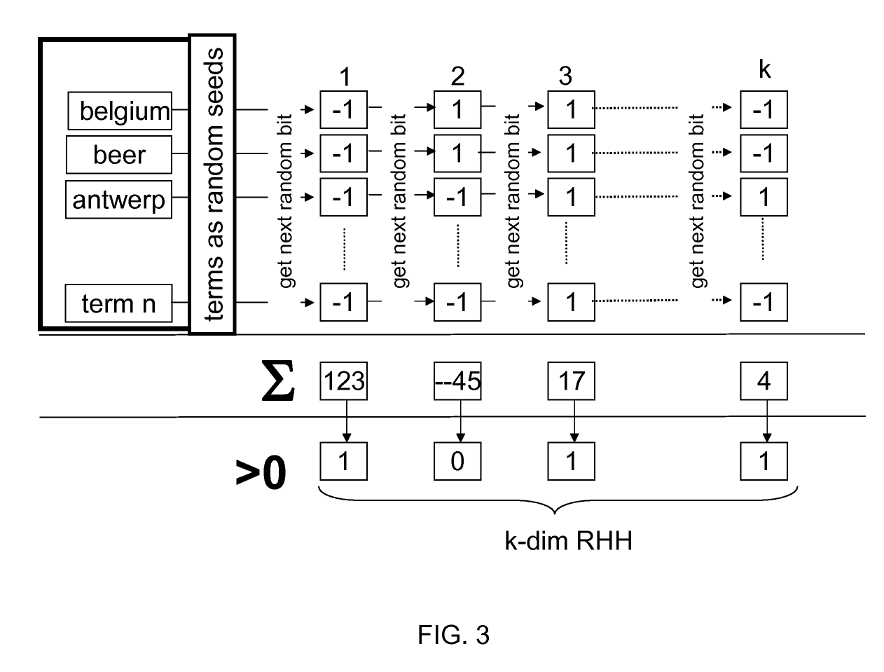

Random hyperplane hashing (“rhh”) can be described as follows: A projection matrix P can be generated from an N×K matrix of random real numbers. For every N-dimensional vector x, vector product r=xP is computed. A zero thresholding operation is performed for every component of the vector to obtain the K-dimensional hash h, i.e. hᵢ=−1 if rᵢ<0 and hᵢ=1 if rᵢ≧0. FIG. 3 illustrates an exemplary manner of generation of hash vectors as described above.

The hash obtained in such a manner is an LSH method for the cosine similarity, i.e., two vectors which have a high cosine correspond to hashes with very small hamming distance in the hash space. The present invention exploits this hashing technique towards representing documents by a K-dimensional hash. A variety of traditional classifiers, such as SVM, Perceptron, Naïve Bayes, etc., can now be used on top of the new representation.

Generally speaking, the hashing scheme utilized does not need to include any particular expertise or knowledge regarding text features. The hashing scheme or method can be configured so as to be language-independent, or to allow for the incorporation of non-word features like n-grams.

A simplified and computationally efficient form of a method utilized in the present invention can be expressed as follows:

Require:
Input document d
Number K of output dimensions

Ensure:

K-dimensional Boolean vector representing d

Computation:

```
1. Create a K dimensional vector v with v[i] = 0 for 1≦ i ≦ k
2. for all terms w in document d do
    a. Set random seed to w // cast w to integer or use hash
    value
    b. For all i in (1,...,K) do
        i. b = sample random bit uniformly from {−1,+1}
        ii. v[i] = v[i] + b
3. for all i in (1,...,K) do
    a. v[i] = sign(v[i])
4. return v
```

The present invention provides a compact, efficient and general scheme to represent documents for performing multi-class classification. The representation is compact enough to be transmitted over the web, is general enough to be used for all kinds of upcoming multi-class classification problems, is cheap enough to be applicable at deployment time, and is sufficiently close to the performance of models that are narrowed down by operational costs.

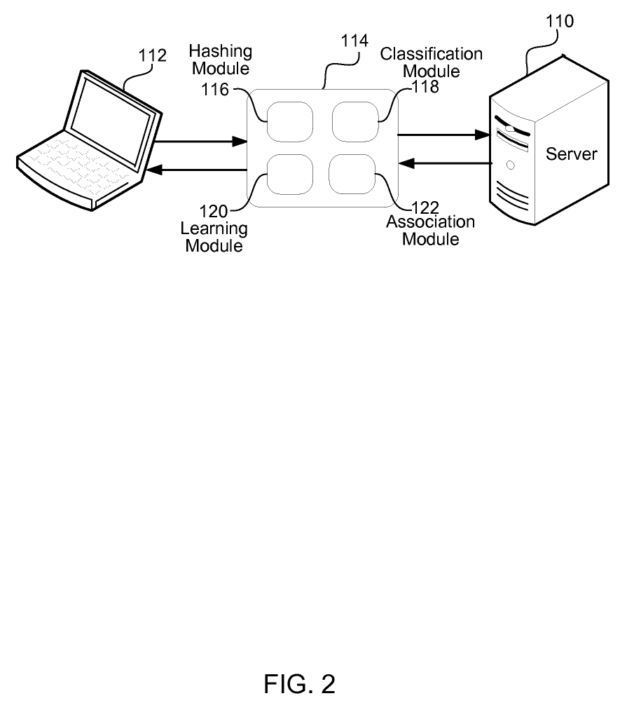

Turning now to FIG. 2, a system for classifying a plurality of documents that form part of a data set is illustrated schematically. The system can include a data set located on a computing device 112. A server 110 can be in communication with the computing device. A processing system 114 can be associated with the server or the computing device. The processing system can be operable to retrieve the plurality of documents from the database located on the computing device. Once retrieved, a hashing representation scheme can be applied to the plurality of documents from the data set to obtain a feature vector representation for each of the plurality of documents. Classification labels can be associated with some of the plurality of documents of the data set (e.g., by hand or other automated assignment) and a learning algorithm can be executed to learn a functional relationship between the feature vector representations of the plurality of documents and the classification labels associated with documents.

Finally, the functional relationship learned can be utilized to associate classification labels with feature vector representations of other documents of the data set so as to provide document classifications.

As shown schematically, the processing system 114 can include a variety of modules. Examples of suitable modules include, without limitation, a hashing module 116 that can be utilized to obtain a feature vector representation of the plurality of documents. A classification module 118 can be utilized to associate classification labels with the plurality of documents of the data set. A learning module 120 can be utilized to learn a functional relationship between the feature vector representation of the plurality of documents and the classification label associated with the at least one document. Finally, an association module 122 can be used to associate classification labels with feature vector representations of other documents of the data set so as to provide document classifications.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

We claim:

1. A method of classifying a plurality of documents that form part of a data set, comprising:
retrieving the plurality of documents located on a computing device;
applying a hashing representation scheme to the plurality of documents from the data set to obtain a feature vector representation of each of the plurality of documents;
associating a classification label with selected documents of the plurality of documents in the data set;
executing a learning algorithm to learn a functional relationship between the feature vector representations of the plurality of documents and the classification label associated with the at least one document; and
utilizing the functional relationship learned to associate classification labels with feature vector representations of other documents of the data set so as to provide document classifications.

2. The method of claim 1, wherein the hashing representation scheme comprises a locality sensitive hashing scheme.

3. The method of claim 1, wherein applying a hashing representation scheme further comprises representing documents by a K-dimensional hash.

4. The method of claim 1, wherein the locality sensitive hashing scheme generates a hash space in which a distance between documents in the data set is preserved in the hash space.

5. The method of claim 1, wherein obtaining a vector representation for a document further comprises extracting a set of feature vectors for a document.

6. The method of claim 1, wherein associating a classification label further comprises applying classification labels to a portion of the documents.

7. The method of claim 1, wherein feature vector representations of the plurality of documents are obtained on at least one client; and
wherein executing the learning algorithm to learn a functional relationship between the feature vector representation of the plurality of documents and the classification label associated with the at least one document is performed on a server remote from the at least one client.

8. The method of claim 1, wherein executing the learning algorithm to learn a functional relationship between the feature vector representation of the plurality of documents and the classification label associated with the at least one document is performed on a client.

9. A system for classifying a plurality of documents that form part of a data set, comprising:
a data set located on a computing device;
a server, in communication with the computing device;
a processing system, the processing system operable to:
retrieve the plurality of documents from the computing device;
apply a hashing representation scheme to the plurality of documents from the data set to obtain a feature vector representation of the plurality of documents;
associate a classification label with the plurality of documents of the data set;
execute a learning algorithm to learn a functional relationship between the feature vector representation of the plurality of documents and the classification label associated with the at least one document; and
utilize the functional relationship learned to associate classification labels with feature vector representations of other documents of the data set so as to provide document classifications.

10. The system of claim 9, wherein the representation scheme comprises a locality sensitive hashing scheme.

11. The system of claim 9, wherein the hashing representation scheme includes representing documents by a K-dimensional hash.

12. The system of claim 9, wherein the locality sensitive hashing scheme generates a hash space in which a distance between documents in the data set is preserved in the hash space.

13. The system of claim 9, wherein the processing system is operable to extract a set of feature vectors for a document.

14. The system of claim 13, wherein the processing system is operable to reduce the dimensionality of the set of feature vectors.

15. The system of claim 9, wherein the processing system is operable to apply classification labels to at least a portion of the documents.

16. The system of claim 9, wherein the documents are stored on at least one client; and
wherein the processing system executes the learning algorithm on a server remote from the at least one client.

17. The system of claim 9, wherein the processing system executes the learning algorithm on a client remote from the server.
